(19) United States
(12) Patent Application Publication
(10) Pub. No.: US 2018/0340649 A1
(43) Pub. Date: Nov. 29, 2018

(54) LADDER MOUNTING SYSTEM

(71) Applicant: Mike Bleazard, Holden, UT (US)

(72) Inventor: Mike Bleazard, Holden, UT (US)

(21) Appl. No.: 15/969,624

(22) Filed: May 2, 2018

Related U.S. Application Data
(60) Provisional application No. 62/511,936, filed on May 26, 2017.

(51) Int. Cl. F16M 13/02; F16B 43/00

(52) U.S. Cl. CPC F16M 13/02; F16B 2043/008; F16B 43/00

(57) ABSTRACT

The ladder mounting system provides a modular ladder storage system for the purpose of storing ladders flat against walls in a vertical orientation. This maximizes valuable space in a home, shop, garage, or storage shed. It keeps any stored ladder easily accessible when needed for quick use. It utilizes a bracket that can be secured to the wall into a stud or into the sheet rock. The device allows users to hang the ladder flush against the wall and up off the floor.

### CROSS REFERENCE TO RELATED APPLICATION

The present application is related to and claims priority to U.S. Provisional Patent Application No. 62/511,936 filed May 26, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mounting brackets and more specifically relates to ladder mounting brackets.

### 2. Description of Related Art

Many individuals leave their ladders leaning up against the wall. This can result in a ladder falling over. If the ladder is stored in the garage, it may be hit with a vehicle. Leaning a ladder up against a wall can also consume valuable space in a garage, shop, or shed. An effective solution is needed.

U.S. Pat. No. 5,819,873 to Ernest D. Higgins relates to a ladder bracket and lock. The described ladder bracket and lock includes a ladder bracket for supporting and suspending a ladder therefrom adjacent a side wall of a structure wherein the ladder bracket is comprised of a back member having a first and second extension arm extending horizontally outward therefrom such that a lock plate is coupled to the distal ends of the extension arms to facilitate the securing and locking of the ladder to the ladder bracket. The lock plate is coupled to the second extension arm such that it pivots in a vertical plane to thereby provide access to the ladder bracket. The lock plate further providing for the use of a padlock thereon to secure the ladder bracket.

### BRIEF SUMMARY OF THE INVENTION

In view of the foregoing disadvantages inherent in the known mounting brackets art, the present disclosure provides a novel ladder mounting system. The general purpose of the present disclosure, which will be described subsequently in greater detail, is to provide a modular ladder storage system for the purpose of storing ladders flat against walls in a vertical orientation. This maximizes valuable space in a home, shop, garage, or storage shed. As designed it keeps any stored ladder easily accessible when needed for quick use. Further, it utilizes a bracket that can be secured to the wall into a stud or into the sheet rock. The present invention allows users to hang the ladder flush against the wall and up off the floor.

A ladder mounting system is disclosed herein. The ladder mounting system includes a mounting bracket assembly having a bracket including; a bracket-body; a first-section; and a second-section; wherein the first-section and the second-section are parallel, the first-section and the second-section may have opposite open ends; wherein the first-section may be configured to be mounted to a surface. The second-section may be configured to receive a top-plate of a ladder and support the ladder; wherein the second-section comprises a depth suitable for receiving a back side of the top-plate of the ladder. As such the mounting bracket assembly may be configured to provide support for mounting at least one item to a surface.

A method of using the ladder mounting system is also disclosed herein. The method of using ladder mounting system may comprise the steps of: providing a ladder mounting system comprising: a mounting bracket assembly having a bracket including a bracket-body; a first-section; and a second-section; wherein the first-section and the second-section are parallel. The first-section and the second-section may have opposite open ends; wherein the first-section may be configured to be mounted to a surface. The second-section may be configured to receive a top-plate of a ladder and support the ladder; wherein the second-section comprises a depth suitable for receiving a back side of the top-plate of the ladder. The mounting bracket assembly may be configured to provide support for mounting at least one item to the surface. The next steps: installing the mounting bracket assembly to a surface; and hanging a ladder from the second-section of the mounting bracket assembly. The method may further comprise the step of: lifting the ladder from the second-section of the mounting bracket assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a ladder mounting system known as “Ladder Mate Home”, constructed and operative according to the teachings of the present disclosure.

FIG. 1 is a front view of the ladder mounting system during an ‘in-use’ condition, according to an embodiment of the disclosure.

FIG. 2A is a side view of the ladder mounting system of FIG. 1, according to an embodiment of the present disclosure.

FIG. 2B is a perspective view of the ladder mounting system of FIG. 1, according to an embodiment of the present disclosure.

FIG. 3 is a perspective view of the ladder mounting system of FIG. 1, according to an embodiment of the present disclosure.

FIG. 4 is a perspective view of the ladder mounting system of FIG. 1, according to an embodiment of the present disclosure.

FIG. 5 is a method of use for the ladder mounting system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to mounting brackets and more particularly to a ladder mounting system as used to improve the storage of ladders.

Generally, Ladder Mate Home provides users with a means for storing a ladder flush against a wall in a vertical orientation. The invention is preferably comprised of a simple plastic bracket. The bracket can be attached to the wall with two #5 screws if attaching directly into a wall stud. If attaching into sheet rock wall then the same two #5 screws would be used, but with the addition of two plastic all point anchors.

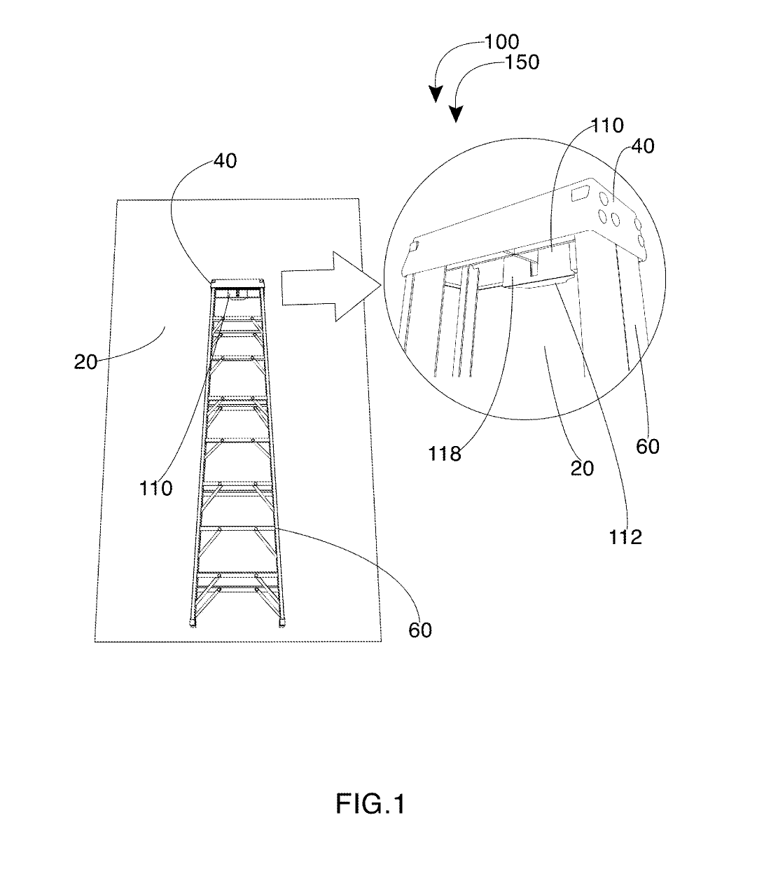

Referring now more specifically to the drawings by numerals of reference, there is shown in FIGS. 1-4, various views of a ladder mounting system 100. FIG. 1 shows a ladder mounting system 100 during an ‘in-use’ condition 150, according to an embodiment of the present disclosure. As illustrated, the ladder mounting system 100 may include a mounting bracket assembly 110 with a bracket 112 including a bracket-body, a first-section 116, and a second section 118. When properly installed using screws 80 driven through at least one counter-sunk aperture 120 into a surface 20 which may be a wall with a stud, the ladder mounting system 100 is able to securely support a ladder 60 in a vertical orientation.

The counter-sunk aperture 120 is shaped to receive and retrain a screw 80, while allowing the screw 80 to penetrate and extend beyond the ladder mounting system 100 and into a surface 20. The surface 20 may be a wall without or without a stud, in which case anchors may be included and screws 80 would be driven into the anchors installed into the surface 20. The ladder mounting system 100 can also be used to secure other items using a provided bungee cord.

According to one embodiment, the ladder mounting system 100 may be arranged as a kit. The kit may include a set of instructions; and wherein the ladder mounting system 100 is arranged as a kit. The instructions may detail functional relationships in relation to the structure of the ladder mounting system 100 (such that the ladder mounting system 100 can be used, maintained, or the like, in a preferred manner).

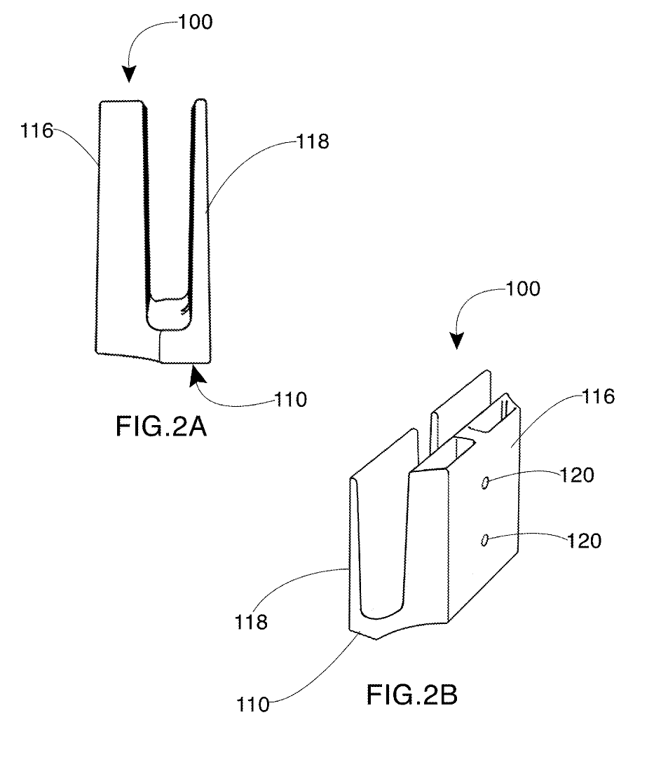

FIGS. 2A and 2B show a side view and a perspective view respectively of the ladder mounting system 100 of FIG. 1, according to an embodiment of the present disclosure. As above, the ladder mounting system 100 may include a mounting bracket assembly 110 with a semi-rigid bracket 112 having a first-section 116 being approximately 3 inches wide and a second-section 118 being about 2 inches wide, and at least one counter-sunk aperture 120 through which a screw 80 can be driven to affix it to a surface 20. The second-section 116 of the bracket 112 includes a channel for receiving the underside portion of a top-plate 40 of a ladder 60 and to secure it in place using friction. The ladder mounting system 100 can be made from one or a combination of materials such as polypropylene, nylon, plastic, ferrous material, and nonferrous material.

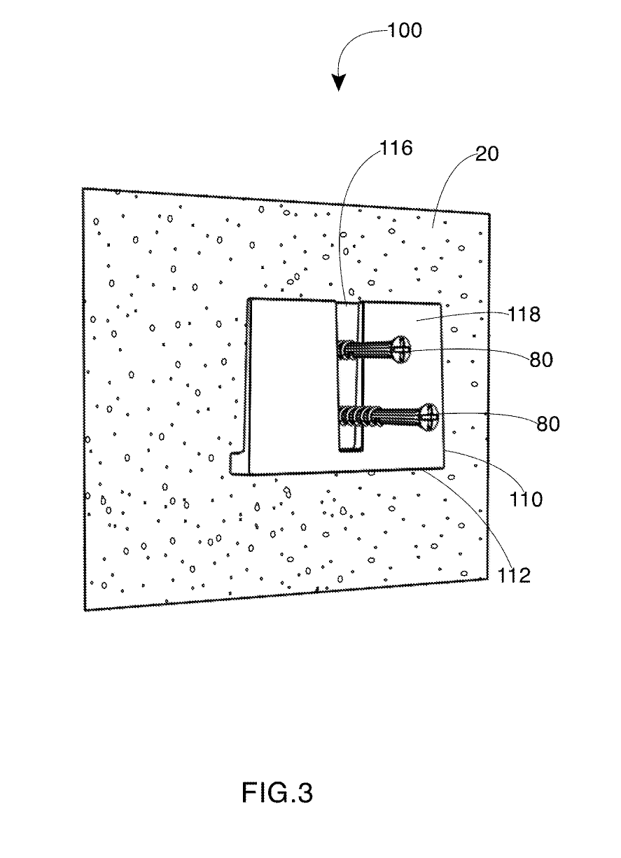

Referring now to FIG. 3 showing a perspective view of the ladder mounting system 100 of FIG. 1, according to an embodiment of the present disclosure. As above, the ladder mounting system 100 may include a mounting bracket assembly 110, with a bracket 112 having a first-section 116 and a second-section 118, and at least one counter-sunk aperture 120 through which a screw 80 can be driven to affix it to a surface 20.

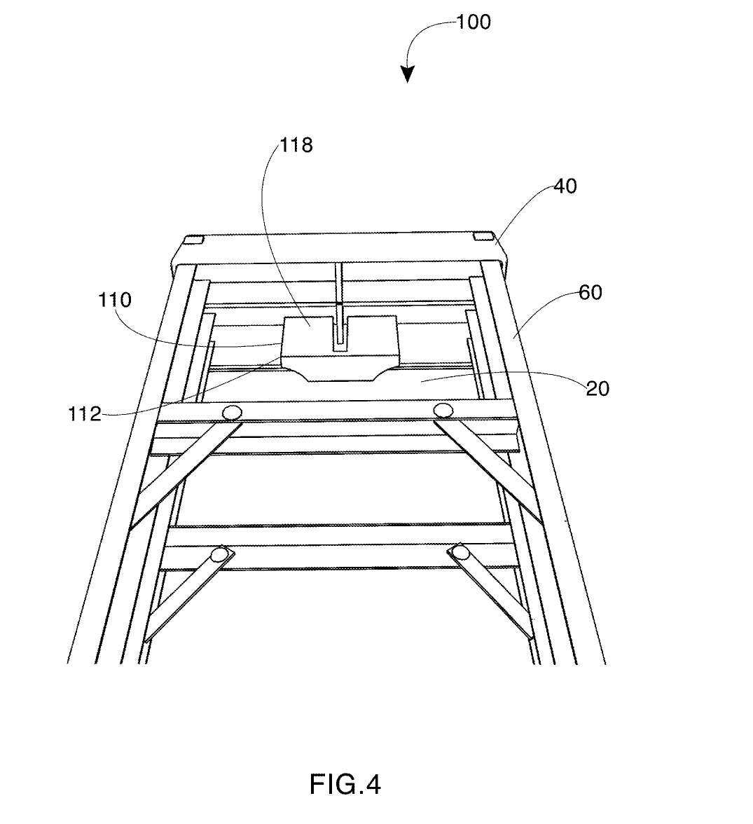

FIG. 4 shows a perspective view of the ladder mounting system 100 of FIG. 1, according to an embodiment of the present disclosure. As above, the ladder mounting system 100 may include a mounting bracket assembly 110 having a first-section 116 and a second-section 118 which are parallel and have opposite ends, and at least one counter-sunk aperture 120.

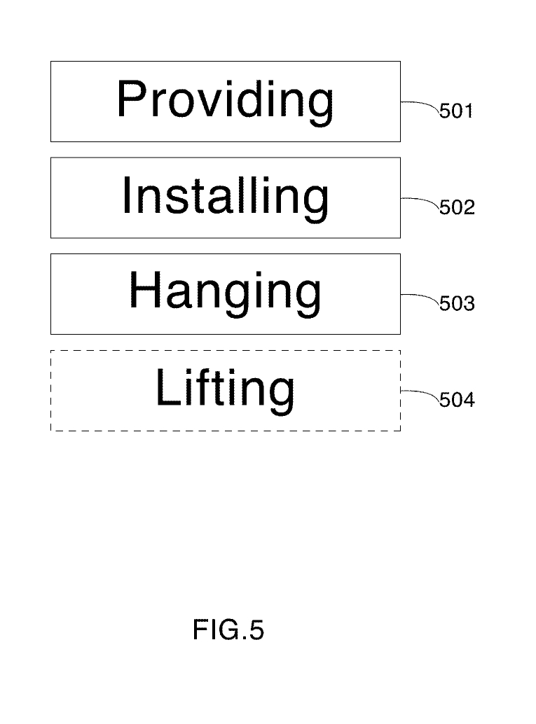

FIG. 5 is a flow diagram 550 illustrating a method for mounting a ladder 500, according to an embodiment of the present disclosure. As illustrated, the a method for mounting a ladder 500 may include the steps of: providing 501 a ladder mounting system 100 comprising: a mounting bracket assembly 110 having; a bracket 112 including; a bracket-body; a first-section 116; and a second-section 118; wherein the first-section 116 and the second-section 118 are parallel, the first-section 116 and the second-section 118 may have opposite open ends; wherein the first-section 116 may be configured to be mounted to a surface 20; wherein the second-section 118 may be configured to receive a top-plate 40 of a ladder 60 and support the ladder 60; wherein the second-section 118 comprises a depth suitable for receiving a back side of the top-plate 40 of the ladder 20; and wherein the mounting bracket assembly 110 may be configured to provide support for mounting at least one item to the surface 20; installing 502 the mounting bracket assembly 110 to a surface 20; and hanging 503 a ladder 60 from the second-section 118 of the mounting bracket assembly 110. The method may further comprise the step of: lifting 504 the ladder 60 from the second-section 118 of the mounting bracket assembly 110.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the ladder mounting system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ladder mounting system comprising:
a mounting bracket assembly having;
a bracket including;
a bracket-body;
a first-section; and
a second-section;
wherein said first-section and said second-section are parallel, said first-section and said second-section having opposite open ends;
wherein said first-section is configured to be mounted to a surface;
wherein said second-section is configured to receive a top-plate of a ladder and support said ladder;
wherein said second-section comprises a depth suitable for receiving a back side of said top-plate of said ladder; and
wherein said mounting bracket assembly is configured to provide support for mounting at least one item to said surface.

2. The ladder mounting system of claim 1, wherein said surface is a wall having a stud.

3. The ladder mounting system of claim 2, wherein said surface is a wall without a stud.

4. The ladder mounting system of claim 3, wherein said system further comprises at least one anchor configured to be installed into a wall without a stud and support a screw.

5. The ladder mounting system of claim 1, wherein said first-section further comprises at least one counter-sunk aperture.

6. The ladder mounting system of claim 5, wherein said at least one counter-sunk aperture is configured to receive and retain a screw, said screw being of sufficient size for a head of said screw to be secured within a counter-sunk portion of said counter-sunk aperture, and to penetrate and extend beyond said at least one counter-sunk aperture and drive into said wall having a stud and into said stud.

7. The ladder mounting system of claim 5, wherein said at least one counter-sunk aperture is configured to receive and retain a screw, said screw being of sufficient size for a head of said screw to be secured within a counter-sunk portion of said counter-sunk aperture, and to penetrate and extend beyond said at least one counter-sunk aperture and drive into said anchor, said anchor being installed into said wall without a stud.

8. The ladder mounting system of claim 1, wherein said second-section further comprises a channel for receiving an underside portion of said top-plate of said ladder.

9. The ladder mounting system of claim 8, wherein said second-section comprises a depth suitable for receiving a back side of said top-plate of said ladder.

10. The ladder mounting system of claim 8, wherein said channel of said second-section comprises a width configured to friction-fittedly receive said back side of said top-plate of said ladder.

11. The ladder mounting system of claim 1, wherein said bracket is semi-rigid.

12. The ladder mounting system of claim 1, wherein said bracket is made from at least one material selected from a group including: polypropylene, nylon, plastic, ferrous material, and nonferrous material.

13. The ladder mounting system of claim 1, wherein said first-section-width is approximately 3 inches.

14. The ladder mounting system of claim 13, wherein said second-section-width is approximately 2 inches.

15. The ladder mounting system of claim 1, wherein said mounting bracket assembly is configured to support said ladder in a substantially vertical orientation.

16. The ladder mounting system of claim 1, wherein said mounting bracket assembly further comprises at least one bungee cord to further secure said at least one item.

17. A ladder mounting system, the ladder mounting system comprising:
a mounting bracket assembly having;
a bracket including;
a bracket-body;
a first-section; and
a second-section;
wherein said first-section and said second-section are parallel, said first-section and said second-section having opposite open ends;
wherein said first-section is configured to be mounted to a surface;
wherein said second-section is configured to receive a top-plate of a ladder and support said ladder;
wherein said second-section comprises a depth suitable for receiving a back side of said top-plate of said ladder;
wherein said mounting bracket assembly is configured to provide support for mounting at least one item to said surface; and
wherein said surface is a wall having a stud;
wherein said first-section further comprises at least one counter-sunk aperture;
wherein said at least one counter-sunk aperture is configured to receive and retain a screw, said screw being of sufficient size for a head of said screw to be secured within a counter-sunk portion of said counter-sunk aperture, and to penetrate and extend beyond said at least one counter-sunk aperture and drive into said wall having a stud and into said stud;
wherein said second-section further comprises a channel for receiving an underside portion of said top-plate of said ladder;
wherein said second-section comprises a depth suitable for receiving a back side of said top-plate of said ladder;
wherein said channel of said second-section comprises a width configured to friction-fittedly receive said back side of said top-plate of said ladder;
wherein said bracket is semi-rigid;
wherein said first-section-width is approximately 3 inches;
wherein said second-section-width is approximately 2 inches; and
wherein said mounting bracket assembly is configured to support said ladder in a substantially vertical orientation.

18. The ladder mounting system of claim 17, further comprising a set of instructions; and
wherein the ladder mounting system is arranged as a kit.

19. A method for mounting a ladder, the method comprising the steps of:
providing a ladder mounting system comprising:
a mounting bracket assembly having; a bracket including; a bracket-body; a first-section; and a second-section;
wherein said first-section and said second-section are parallel, said first-section and said second-section having opposite open ends;
wherein said first-section is configured to be mounted to a surface;
wherein said second-section is configured to receive a top-plate of a ladder and support said ladder;
wherein said second-section comprises a depth suitable for receiving a back side of said top-plate of said ladder; and
wherein said mounting bracket assembly is configured to provide support for mounting at least one item to said surface;
installing the mounting bracket assembly to a surface; and
hanging a ladder from the second-section of the mounting bracket assembly.

20. The method of claim 19, further comprising the step of:
lifting the ladder from the second-section of the mounting bracket assembly.
